(19) United States
(12) Patent Application Publication
(10) Pub. No.: US 2007/0055644 A1
(43) Pub. Date: Mar. 8, 2007

(54) Global dynamic variable storage for SQL procedures

(75) Inventors: Margaret Ann Bernal, San Jose, CA (US); Yao-Ching Stephen Chen, Saratoga, CA (US); Ding-Wei Chieh, Cupertino, CA (US); Christopher John Crone, San Jose, CA (US); Baoqiu Cui, San Jose, CA (US); Tammie Dang, Morgan Hill, CA (US); Marion B. Farber, San Jose, CA (US); Fen-Ling Lin, San Jose, CA (US); Chunfeng Pei, San Jose, CA (US); Yumi Kimura Tsuji, San Jose, CA (US); Jay A. Yothers, Gilroy, CA (US); Liyan Zhou, San Jose, CA (US)

Correspondence Address: Sawyer Law Group LLP, P.O. Box 51418, Palo Alto, CA, 94303, US

(73) Assignee: International Business Machines Corporation, Armonk, NY (US)

(21) Appl. No.: 11/222,884

(22) Filed: Sep. 8, 2005

(51) Int. Cl. G06F 17/30

(52) U.S. Cl. 707/1

(57) ABSTRACT

A method and system for using a procedure residing and executed entirely within a database system is disclosed. The procedure utilizes at least one variable, which has a plurality of attributes. The method and system include defining the at least one variable as at least one global variable prior to calling of the procedure. Defining the global variable(s) includes informing the database system of the plurality of attributes of the variable(s) and allowing the database system access to the at least one variable. The method and system also include tracking the global variable(s).

### FIELD OF THE INVENTION

The present invention relates to database systems, and more particularly to a method and system for improving execution of procedures residing in the database system.

### BACKGROUND OF THE INVENTION

FIG. 1 is a diagram of a conventional database system 10 used with a host 20. The conventional database system 10 includes a conventional database engine 12, a conventional database catalog 14, a conventional memory 16, and the database 18. The database engine 12 executes instructions for the conventional database system 10. The conventional catalog 14 stores various items used by the conventional database system 10, such as procedures, described below. The conventional memory 16 is used by the conventional database engine 12 for storage when executing instructions. The conventional database 18 stores information, typically in the form of tables or records. Using the conventional database engine 12, the host 20 can query, add information to, and perform other operations on the data stored in the conventional database 12.

FIG. 2 is a block diagram depicting an example of a simple procedure 30. Such procedures may be used to perform operations in the conventional database system 10. The procedure 30 includes a logic portion 32 and a database request portion 34. For the procedure 30 depicted, the logic portion describes variables A and B, as well as the parameter NUM. The variables are local variables for the procedure 30. When the procedure runs entirely in the database engine, these variables reside entirely within the conventional database system 10. The variables may be used in static or dynamic SQL statements in the stored procedure 30.

The database request portion 34 is used to perform operations on the database 18, for example writing to the database 18 and reading from the database. The database request portion 34 includes database request statement(s), which are used to perform the operations. For example, database request statements may typically be SQL statements. Such database request statements include but are not limited to the insert statement 36, selects statement, and other database request statements. The database request portion 34 typically utilizes the variables in the logic portion 32.

FIG. 3 is a flow chart depicting a conventional method 40 for implementing a procedure, such as the procedure 30. The procedure 30 is called, via step 42. A structure, typically termed a SQLDA, is built when the procedure is implemented, via step 44. The SQLDA describes the attributes of the variables in the logic portion 32 of the procedure 30. For example, the SQLDA may indicate which are host variables, describe the data type for the variables, the value of each variable, and the buffer containing each variable. The database request portion 34 is implemented, via step 46. In order to process database request statements 36 in the database request portion 34, various operations may be performed for the variables. Thus, bind-in operations are performed, if required, during execution of the procedure 30, via step 48. Bind-in operations bring in the variables and perform related processing, such as processing incompatibilities of the variable. Bind-in operations may be performed for certain database request statements that involve variables. The procedure 30 would typically require the bind-in operation in order to implement the insert statement in the database request portion 34. In addition, bind-out operations are performed if required, during execution of the procedure 30, via step 50. Bind-out operations write out data from the database 18. Both bind-in and bind-out operations performed in steps 48 and 50 typically utilize the SQLDA structure. Consequently, the procedure 30 may be implemented.

Although the procedure 30 may be implemented, one of ordinary skill in the art may readily recognize that the implementation may be inefficient. In particular, processes involved in utilizing the variables defined by the procedure 30 may be costly in terms of time and/or resources. For example, bind-in and bind-out operations performed in steps 48 and 50, respectively, involve data movement and validation of data types and are thus costly. This is true even for a procedure 30 that resides entirely within the conventional database system 10. A procedure 30 which resides entirely within the conventional database system 10 may still require bind-in and bind-out operations to be performed despite that fact that the conventional database system 10 should have information relating to all of the variables.

Accordingly, what is needed is a method and system for more efficiently executing procedures, particularly procedures that reside and are executed entirely within the database system. The present invention addresses such a need.

### BRIEF SUMMARY OF THE INVENTION

The present invention provides a method and system for using a procedure residing and executed entirely within a database system. The procedure utilizes at least one variable, which has a plurality of attributes. The method and system comprise defining the at least one variable as at least one global variable prior to calling of the procedure. Defining the global variable(s) includes informing the database system of the plurality of attributes of the at least one variable and allowing the database system access to the at least one variable. The method and system also comprise tracking the at least one global variable.

According to the method and system disclosed herein, the present invention provides a method and system for more efficiently implementing procedures within a database system.

### BRIEF DESCRIPTION OF SEVERAL VIEWS OF THE DRAWINGS

FIG. 1 is a diagram of a conventional database system used with a host.

FIG. 2 is a block diagram depicting an example of a simple procedure.

FIG. 3 is a flow chart depicting a conventional method for implementing a procedure.

FIG. 4 is a flow chart depicting one embodiment of a method in accordance with the present invention for using a procedure.

FIG. 5 is a diagram of on embodiment of a database system in accordance with the present invention.

FIG. 6 is a diagram depicting one embodiment in accordance with the present invention of structures generated for a particular procedure.

FIG. 7 is a flow chart depicting another embodiment of a method in accordance with the present invention for using a procedure.

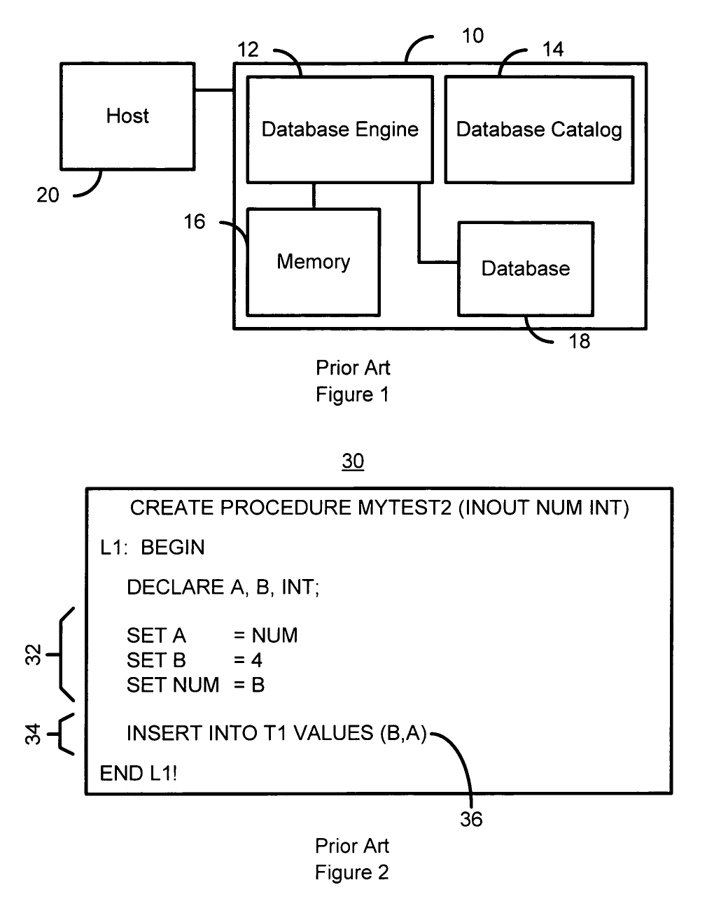

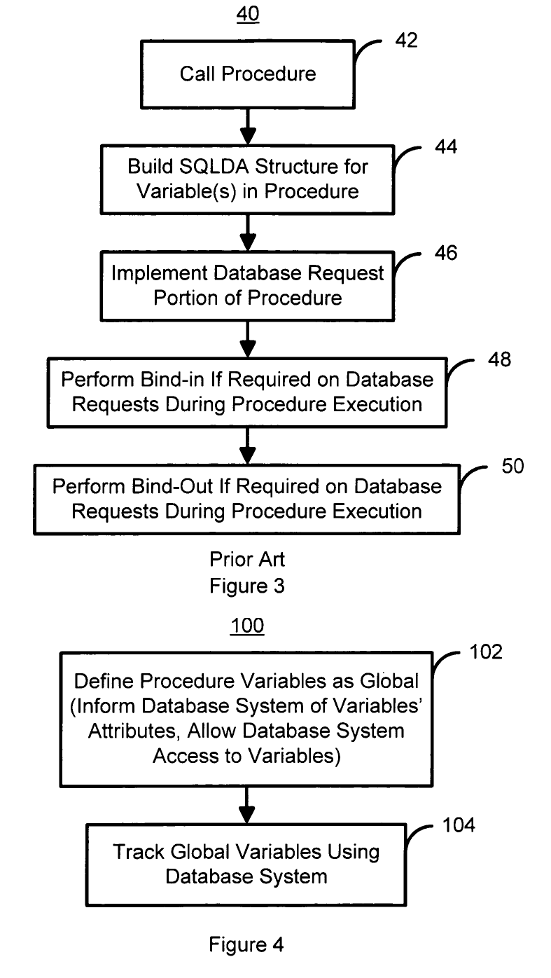

### DETAILED DESCRIPTION OF THE INVENTION

The present invention relates to database systems. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for using a procedure residing and executed entirely within a database system. The procedure utilizes at least one variable, which has a plurality of attributes. The method and system comprise defining the at least one variable as at least one global variable prior to calling of the procedure. Defining the global variable(s) includes informing the database system of the plurality of attributes of the at least one variable and allowing the database system access to the at least one variable. The method and system also comprise tracking the at least one global variable.

The present invention will be described in terms of a particular procedure. However, one of ordinary skill in the art will readily recognize that the method and system may be used with other procedures having other and/or additional portions such as variables and database request statements. The present invention is also described in the context of particular methods and database systems. However, for ease of explanation steps in the method and portions of the database system may be omitted or combined. One of ordinary skill in the art will readily recognize, therefore, that the method and system in accordance with the present invention may include other and/or additional steps or portions.

To more particularly describe the method and system in accordance with the present invention, refer to FIG. 4, depicting one embodiment of a method 100 in accordance with the present invention for using a procedure. The procedure is preferably a procedure such as the procedure 30. Consequently, the procedure preferably has a logic portion and a database request portion. In a preferred embodiment, the logic portion describes the variables used by the procedure, while the database request portion includes the relevant database request statements. The method 100 preferably applies to procedures that reside and are executed entirely within the database system.

The variable(s) for the procedure are defined as global variables prior to the procedure being called, via step 102. The variables are considered to be global because the variables are preferably accessible by all database request statements in the procedure. Step 102 includes informing the database system of the attributes of each of the variables. For example, the database system may be informed of the type, length, encoding scheme, and value of the variables. In addition, the database is allowed access to the variables in step 102. As discussed above, the variables of the procedure are defined as global variables prior to the procedure being called. In a preferred embodiment, this defining occurs upon building or compiling of the procedure. Thus, step 102 is preferably performed well in advance of the procedure being called.

The global variable(s) are tracked by the database system, via step 104. In a preferred embodiment, the database engine tracks the variables. The tracking includes determining the locations as well as the status of the remaining attributes of the variables. For example, the database system may track the value of each variable in addition to the location. As a result, when the variable is called by a database request statement, the database system is capable of accessing at the location at which the variable is stored and using the variable in executing the database request statements for the procedure. In one embodiment, step 104 is performed using relative offsets and employing a relocation table or directory to convert the relative offsets to pointers to the actual location(s) of the variable(s).

Thus, using the method 100, the variables can be accessed and tracked by the database system, particularly the database engine. Consequently, a specialized structure, such as a SQLDA, is not necessary for managing the variables. In addition, bind-in and bind-out operations can be avoided. This is achieved because the variables are global variables recognized and managed by the database system. Consequently, for statements such as insert or select statements, simple read and write operations not requiring the time of bind-in or bind-out operations may be performed. Thus, using the method 100, a database system can more efficiently use a procedure that resides and is executed entirely within the database system.

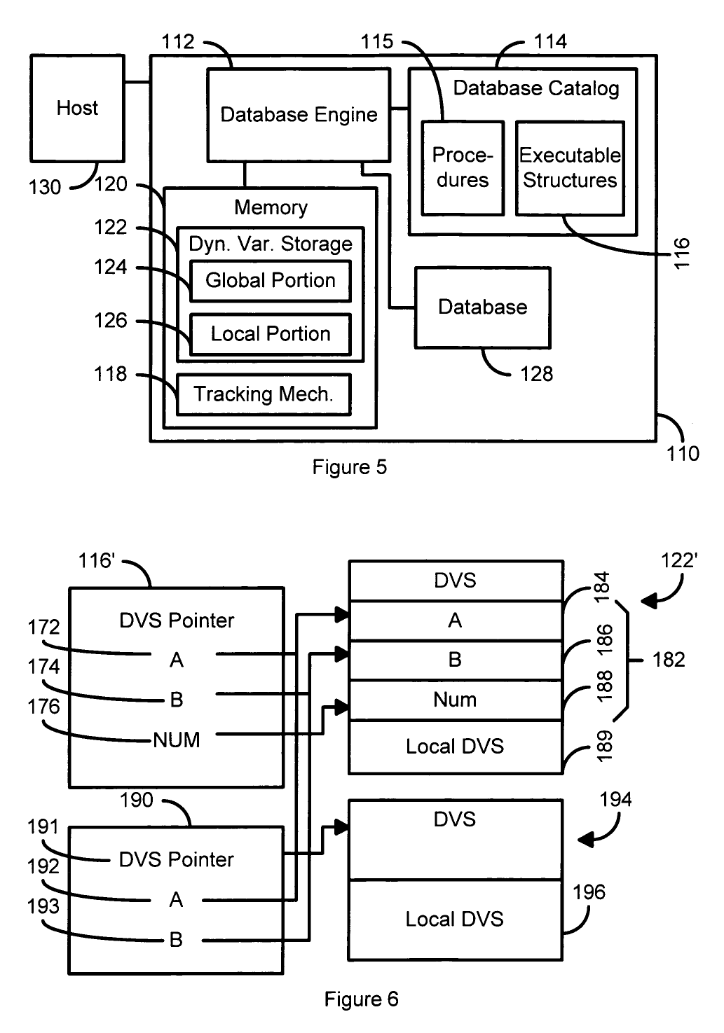

FIG. 5 is a diagram of on embodiment of a database system 110 in accordance with the present invention shown in conjunction with a host 130. The database system 110 includes a database engine 112, a database catalog 114, memory 120, and database 128. The database engine 112 executes instructions for the database system 110. The catalog 114 stores various items used by the database system 110, such as procedures 115 and the executable structures 116, described below. The memory 120 is used by the database engine 112 for storage when executing instructions. In addition, during implementation of the procedures, a portion of the memory 120 is allocated for dynamic variable storage 122, discussed below. The database 128 stores information, typically in the form of tables or records.

Also depicted in the database system 110 are procedures 115, executable structures 116, tracking mechanisms 118, and dynamic variable storage 122. The procedures 115 reside and are executed within the database system 110. The procedure 30 depicted in FIG. 2 is an example of one such procedure 115. Referring back to FIG. 5, each of the procedures 115 includes a logic portion (not explicitly shown) and a database request portion (not explicitly shown). The logic portion of each of the procedures 115 includes global variables used by the same procedure.

The executable structures 116 correspond to the logic portion of the procedures 115 and are generated prior to the corresponding procedures being called. In a preferred embodiment, the executable structures 116 are generated when the corresponding procedures are built, then stored in the catalog 114. The executable structures 116 describe how the database engine 112 is to execute the logic portion of the procedures 115. Consequently, the executable structures 116 effectively include executable code that describes the attributes of the variables used by the procedures 115 to which the executable structures 116 correspond. Thus, the executable structures 116 effectively define the variables in the procedures 115 to be global by informing the database engine 112 of the attributes of the variables and allowing the database engine 112 access to the variables. Thus, the variables may be used by all of the database request statements in the procedure(s) 115 to which the executable structure(s) 116 correspond. The executable structure(s) 116 allow the database engine 112 to access the variables for the procedure(s) 115.

The tracking mechanisms 118 are used to allow the database engine 112 to determine at least the locations of the variables corresponding to the executable structures 115. In a preferred embodiment, the tracking mechanisms 118 also allow the database engine 112 to track the remaining attributes of the variables. For example, the database system may track the value of each variable in addition to the location. In one embodiment, the tracking mechanisms 118 include relocation tables or directories used to convert relative offsets to pointers to the actual location(s) of the variable(s).

The dynamic variable storage 122 is used in executing the procedures 115 and is generated after the corresponding one(s) of the procedures 115 are called. The dynamic variable storage 122 has a global portion 124, which corresponds to the executable structures 116 and a local portion 126. The global portion 124 includes storage allocated for the variables described in the executable procedures 115. The local portion 126 includes storage allocated specifically for the database request statements in the procedures 115 being executed. Both the global portion 124 and the local portion 126 are preferably allocated once the corresponding one or more of the procedures 115 is invoked.

FIG. 6 is a diagram depicting one embodiment in accordance with the present invention of structures generated for a particular procedure. FIG. 6 depicts executable structure 116′, dynamic variable storage 122′, database request statement executable structure 190, and dynamic variable storage 194. The executable structure 116′ is a particular one of the executable structures 116 and corresponds to a particular procedure 115 shown in FIG. 5. Similarly, the dynamic storage 122′ corresponds to a particular embodiment of at least a portion of the dynamic storage 122. The specifics of the executable structure 170, dynamic storage 180, and database request executable structure 190 shown also correspond to the procedure 30 depicted in FIG. 4. However, the principles described herein apply with full force to other procedures 115, other executable structures 116, and other dynamic variable storage 122.

The executable structure 116′ corresponds to the logic portion 32 of the procedure 30. The executable structure 116′ includes a pointer 172 to the dynamic variable storage 122′. In addition, the executable structure 116′ provides definitions 174, 176, and 178 of the variables A and B as well as the parameter NUM, respectively. The definitions 174, 176, and 178 also point to the locations 184, 186, and 188 in the global dynamic variable storage 182 of the dynamic variable storage 122′. In addition, the definitions 172, 174, and 176 effectively define the variables A and B and the parameter NUM to be global, as discussed above. Consequently, the database engine 112 is informed of and can access the variables A and B and the parameter NUM.

The dynamic variable storage 122′ is preferably allocated after the procedure 30 is invoked and includes global storage 182 as well as local storage 189. The global storage 182 corresponds to the variables and the executable structure 116′. The global storage includes locations 184, 186, and 188 store at least the values of the variables A, B, and NUM, respectively and thus correspond to items 172, 174, and 176, respectively. The dynamic variable storage 122′ may also include local storage 189, for use when executing the logic portion of procedure 130.

The executable structure 190 corresponds to the database request portion 34 of the procedure 30 and is preferably generated prior to the procedure 30 being invoked. Also in a preferred embodiment, the executable structure 190 is generated at substantially the same time as the executable structure 122′. The database request executable structure 190 includes a mechanism for finding a location of the global variable(s) at execution time. The executable structure 190 includes a pointer 192 to the dynamic variable storage 196 (described below). In addition, the executable structure 190 allows the variables A and B to be accessed by providing pointers 192 and 193 to the appropriate definitions variables 184 and 186. Consequently, the database engine 112 can access the variables A and B and the parameter NUM.

The dynamic variable storage 194 corresponds to the executable structure 190 and is allocated after the procedure 30 is invoked. The dynamic variable storage 194 corresponds to the database request portion 34 of the database request. The dynamic variable storage 194 includes local storage 196 that is specific to the database request statement. The local storage 196 is used for storage during execution of the database request statement, the insert statement, of the procedure 130.

Referring to FIGS. 5 and 6, the executable structures 116, 116′, and 190 are provided before the procedures 115 and 30 are called. In a preferred embodiment, the executable structures 116, 116′, and 190 are provided when the procedures 115 and 130 are built and compiled. When the procedure 115 or 30 is actually called, the executable structures 116, 116′, or 190 are used to implement the logic portion 32 and database request portion of the procedure 116 and 30. In so doing, the dynamic variable storage 122 and 122′ are allocated. In addition, the database engine 112 may use the portions 172, 174, 176, and 178 of the executable structure 116′ in combination with the tracking mechanism 118 to access the locations 184, 186, and 188. Thus, the variables, such as the variables A and B, for the procedures 115 and 30 can be read and or written during execution of the procedure 115 or 30.

Using the database system 110, particularly the executable structures 116 and tracking mechanism 118 in conjunction with the dynamic variable storage 122, the variables in the procedures 115 can be accessed by the database engine 112. A specialized structure, such as a SQLDA, is not necessary for managing the variables. Instead, the database engine 112 may access the global variables corresponding to the executable structures 116. In addition, bind-in and bind-out operations for the variables on each database requests within the same procedure can be avoided. The database system 110 may, therefore, operate more efficiently.

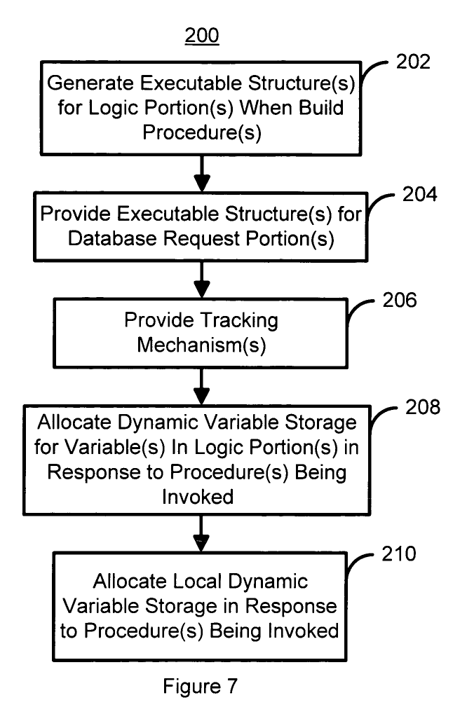

FIG. 7 is a flow chart depicting another embodiment of a method 200 in accordance with the present invention for using a procedure. The method 200 is described in the context of the database system 110 and the structures 116′, 122′, and 190. The executable structures 116 or 116′ for the logic portions of the procedures 115 are generated prior to calling of the procedures 115, via step 202. The executable structure 190 for the database request portion 32 is also generated, via step 204. Step 204 is also preferably performed prior to calling of the procedure. The mechanism 118 for tracking the variables is generated, via step 206. Step 206 includes providing the relocation directory or table for converting the variable(s) to their location(s). In response to the procedure 115 or 30 being called, the dynamic variable storage 122 or 122′ is allocated, via step 208. Thus, the global storage 182 is allocated in step 208. As a result, the database engine 112 is given access to the variables for the procedure 115 and/or 30. The dynamic variable storage 194 is also allocated in response to the procedure 115 or 30 being called, via step 210. Consequently, local dynamic variable storage 196 required for execution of the procedure 115 or 130 is also allocated at run time. The procedure 115 or 30 can thus be implemented by the database system 110.

Thus, using the method 200, the structures 116 and 116′, 118, 122, 122′ and 194, are provided at the appropriate times. Consequently, the variables in the procedures 115 can be accessed by the database engine 112 without requiring bind-in and bind-out operations. As a result, the database system 110 can operate more efficiently.

A method and system for using a procedure in a database system more efficiently has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A method for using a procedure residing and executed entirely within a database system, the procedure utilizing at least one variable, the at least one variable having a plurality of attributes, the method comprising:
defining the at least one variable as at least one global variable prior to calling of the procedure, the defining including informing the database system of the plurality of attributes of the at least one variable and allowing the database system access to the at least one variable.

2. The method of claim 1 further comprising:
tracking the at least one global variable.

3. The method of claim 1 wherein the procedure includes a logic portion including the at least one variable and wherein the defining further includes:
generating an executable structure for the logic portion, the executable structure for informing the database system of the plurality of attributes of the at least one variable and allowing the database system access to the at least one variable.

4. The method of claim 3 wherein the procedure includes a database request portion, the method including:
generating a database request executable structure for the database request portion prior to calling of the procedure.

5. The method of claim 2 wherein the tracking further includes:
providing a mechanism for determining at least one location of the at least one variable.

6. The method of claim 5 wherein the mechanism providing further includes:
providing a relocation directory converting the at least one variable to at least one location of the at least one variable.

7. The method of claim 1 further comprising:
allocating dynamic variable storage for the at least one global variable after the procedure is called.

8. The method of claim 7 wherein the procedure includes a logic portion corresponding to the at least one variable and wherein the global dynamic variable storage corresponds to the logic portion.

9. A system for using a procedure residing and executed entirely within a database system, the procedure utilizing at least one variable, the at least one variable having a plurality of attributes, the system comprising:
an executable structure for defining the at least one variable as at least one global variable prior to the procedure being called, the executable structure informing the database system of the plurality of attributes of the at least one variable and allowing the database system access to the at least one variable.

10. The system of claim 9 further comprising:
a mechanism for tracking the at least one global variable.

11. The system of claim 9 wherein the procedure includes a logic portion including the at least one variable, wherein the executable structure corresponds to the logic portion.

12. The system of claim 11 wherein the procedure includes a database request portion, the system further including:
a database request executable structure for the database request portion prior to calling of the procedure, the database request executable structure including a mechanism for finding a location of the at least one global variable at execution time.

13. The system of claim 10 wherein the mechanism for tracking further determines at least one location of the at least one variable.

14. The system of claim 13 wherein the mechanism for tracking further converts the at least one variable to at least one location of the at least one variable.

15. The system of claim 10 further comprising:
dynamic variable storage for the at least one global variable after the procedure is called.

16. The system of claim 15 wherein the dynamic variable storage corresponds to the logic portion, the dynamic variable storage being generated after the procedure is called.

17. A computer-readable medium containing a program for using a procedure residing and executed entirely within a database system, the procedure including a logic portion and a database request portion, the program including instructions for:
defining the at least one variable as at least one global variable prior to calling of the procedure, the defining including informing the database system of the plurality of attributes of the at least one variable and allowing the database system access to the at least one variable; and
tracking the at least one global variable.
